(19) United States
(12) Patent Application Publication
(10) Pub. No.: US 2026/0273944 A1
(43) Pub. Date: Sep. 17, 2026

(54) INK REPLENISHMENT SYSTEM

(71) Applicant: SEIKO EPSON CORPORATION, Tokyo (JP)

(72) Inventors: Tadahiro MIZUTANI, Shiojiri-shi (JP); Takumi NAGASHIMA, Matsumoto-shi (JP); Tadashi WATANABE, Matsumoto-shi (JP); Yuta KOIKE, Matsumoto-shi (JP)

(73) Assignee: SEIKO EPSON CORPORATION, Tokyo (JP)

(21) Appl. No.: 19/565,872

(22) Filed: Mar. 13, 2026

(30) Foreign Application Priority Data
Mar. 14, 2025 (JP) 2025-041049

(51) Int. Cl. B41J 2/175

(52) U.S. Cl. CPC B41J 2/17506; B41J 2/17596

(57) ABSTRACT

An ink replenishment system includes an ink replenishment container and a printer. The printer includes an ink inlet portion at a tip end of the ink introduction member, the printer includes a sealing cap mounted from a tip end side of the ink introduction member, the sealing cap includes a first seal portion that seals the ink introduction member from an outside of the printer at a first seal position, the ink outlet portion of the ink replenishment container includes a second seal portion that seals the ink introduction member from the outside at a second seal position of the ink introduction member, and a first sealing region from the tip end of the ink introduction member to the first seal position includes a second sealing region from the tip end of the ink introduction member to the second seal position.

The present application is based on, and claims priority from JP Application Serial Number 2025-041049, filed Mar. 14, 2025, the disclosure of which is hereby incorporated by reference herein in its entirety.

### BACKGROUND

### 1. Technical Field

The present disclosure relates to an ink replenishment system.

### 2. Related Art

JP-A-2023-43905 discloses a configuration of an ink replenishment container which is coupled to an ink inlet flow path member in an inverted orientation and replenishes ink to a printer having a tank. The ink replenishment container is detached from the ink inlet flow path member after the ink replenishment. When ink is not replenished, a sealing cap is mounted to the ink inlet flow path member. A portion of the ink inlet flow path member that is sealed by the sealing cap has a configuration in which ink adhering to an outer peripheral surface of the ink inlet flow path member is less likely to dry.

However, in the configuration described in JP-A-2023-43905, in a portion of the ink inlet flow path member which is not sealed by the sealing cap, that is, in an exposed portion of the outer peripheral surface, moisture in adhering ink evaporates and the ink thickens, so that a friction coefficient decreases. Therefore, at the time of ink replenishment, the ink replenishment container floats up while sliding on the outer peripheral surface due to a reaction force of a spring of a spring valve mounted inside the ink replenishment container, and, as a result, there is a possibility that such inconveniences occur that an ink replenishment amount to the tank decreases and an ink replenishment time increases.

### SUMMARY

An ink replenishment system includes an ink replenishment container, and a printer in which ink is replenished to an ink storage portion from the ink replenishment container via an ink introduction member, in which the ink replenishment container includes an ink accommodating portion configured to accommodate the ink, an ink outlet portion that is in fluid communication with the ink accommodating portion, and a valve disposed inside the ink outlet portion, the valve being closed by being biased in a first direction from the ink accommodating portion toward the ink outlet portion by an elastic member, the valve being opened by being pushed in a second direction opposite to the first direction against the bias by the ink introduction member that is coupled to the ink outlet portion, the printer includes an ink inlet portion at a tip end of the ink introduction member, the printer includes a sealing cap mounted from a tip end side of the ink introduction member, the sealing cap includes a first seal portion that seals the ink introduction member from an outside of the printer at a first seal position in a state in which the sealing cap is mounted on the ink introduction member, the ink outlet portion of the ink replenishment container includes a second seal portion that seals the ink introduction member from the outside at a second seal position of the ink introduction member in a state in which the ink outlet portion is coupled to the ink introduction member, and a first sealing region from the tip end of the ink introduction member to the first seal position includes a second sealing region from the tip end of the ink introduction member to the second seal position.

### BRIEF DESCRIPTION OF THE DRAWINGS

FIG. 1 is a perspective view showing a configuration of a printer.

FIG. 2 is a perspective view showing a configuration of an ink replenishment system.

FIG. 3A is a sectional view showing a configuration of the ink replenishment container.

FIG. 3B is an enlarged sectional view showing a portion IIIB of the ink replenishment container shown in FIG. 3A.

FIG. 4 is a sectional view showing a configuration of an ink tank.

FIG. 5 is a sectional view showing a configuration of the ink tank.

FIG. 6 is a sectional view showing a configuration of the ink replenishment system.

FIG. 7 is an enlarged sectional view showing a portion VII of the ink replenishment system shown in FIG. 6.

FIG. 8 is a sectional view showing a configuration of the ink replenishment system.

FIG. 9 is a sectional view showing a configuration of an ink replenishment system in the related art.

FIG. 10 is a sectional view showing a configuration of an ink replenishment system in the related art.

FIG. 11A is a sectional view showing a configuration of the ink replenishment system.

FIG. 11B is an enlarged sectional view showing a portion XIB of the ink replenishment system shown in FIG. 11A.

FIG. 12A is a sectional view showing a configuration of an ink replenishment system according to a modification.

FIG. 12B is a sectional view showing a configuration of the ink replenishment system according to the modification.

FIG. 13 is a sectional view showing a configuration of the ink replenishment system according to the modification.

### DESCRIPTION OF EMBODIMENTS

Hereinafter, with reference to the drawings, a configuration of an ink replenishment system 1000 will be described. In the following drawings, three axes orthogonal to each other will be described as an X-axis, a Y-axis, and a Z-axis. A direction along the X-axis is set as an “X direction”, a direction along the Y-axis is set as a “Y direction”, and a direction along the Z-axis is set as a “Z direction”. A direction of an arrow is set as a + direction, and a direction opposite to the + direction is set as a − direction. In addition, viewing from a +Z direction or a −Z direction is also referred to as a plan view or a planar view.

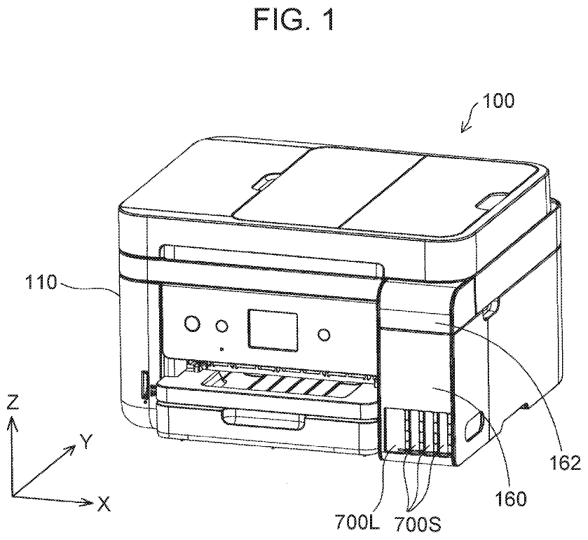

First, a configuration of a printer 100 will be described with reference to FIG. 1.

As shown in FIG. 1, the printer 100 is an ink jet printer that ejects ink onto a print medium and performs printing. The printer 100 includes a housing 110. A carriage (not shown) that is movable in a main scanning direction (X-axis direction) is provided inside the housing 110. A print head that ejects ink onto the print medium is installed in the carriage.

An ink tank accommodating unit 160 that accommodates a plurality of ink tanks 700S and 700L is provided at one end of a front surface of the housing 110. The ink tank accommodating unit 160 includes an openable/closable lid 162 at an upper portion thereof. For example, the ink tanks 700S are small-capacity tanks, and the ink tank 700L is a large-capacity tank. Hereinafter, the ink tanks 700L and 700S will be simply referred to as an ink tank 700.

The ink tanks 700 is coupled to the print head of the carriage by a tube (not shown). That is, the ink tank 700 is a stationary ink tank that is not mounted on the carriage of the printer 100. In addition, the ink tank 700 is an ink replenishment type ink tank in which ink is replenished from an ink replenishment container 200 when a remaining amount of ink decreases.

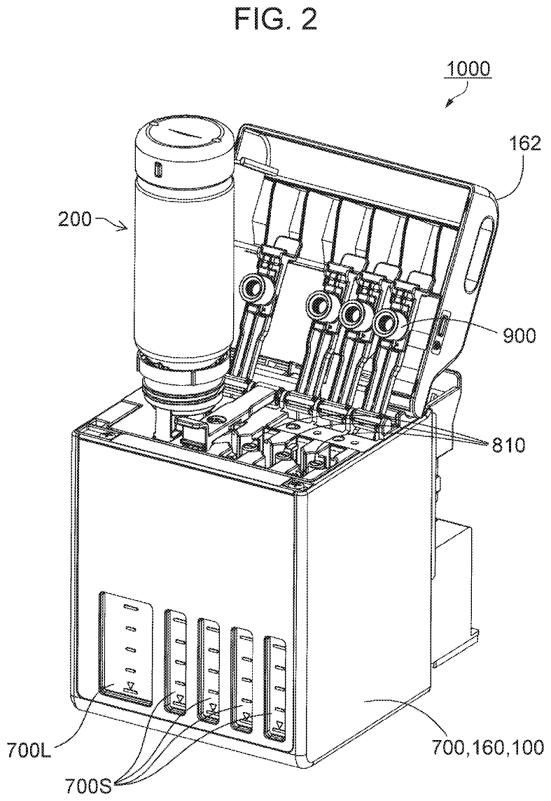

Next, the configuration of the ink replenishment system 1000 will be described with reference to FIG. 2.

As shown in FIG. 2, the ink replenishment system 1000 has the ink replenishment container 200 and the printer 100 in which ink is replenished from the ink replenishment container 200 to the ink tank 700.

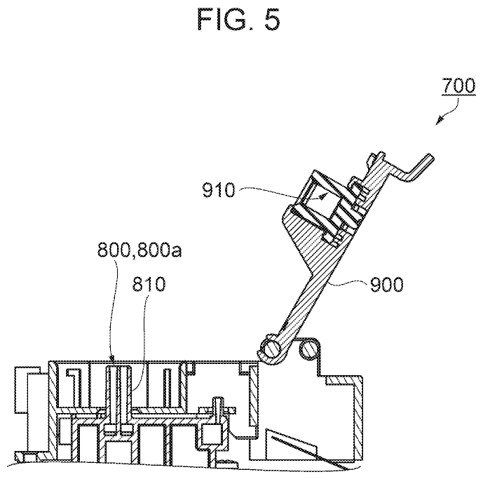

A front surface of the ink tank 700 is formed of a transparent member so that the remaining amount of ink in the ink tank 700 can be seen from the outside. When the remaining amount of ink is low, as shown in FIG. 2, the lid 162 is opened, and ink can be replenished from an ink introduction member 810 (see FIG. 5) of the ink tank 700. Specifically, the tubular ink introduction member 810 is provided on an upper surface of the ink tank 700 in order to replenish ink in the ink tank 700.

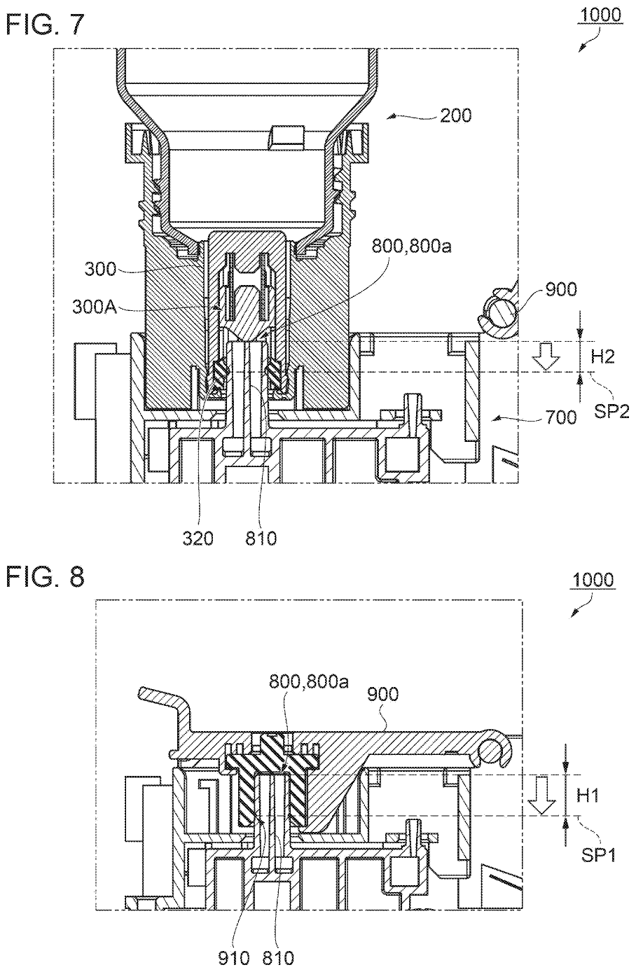

The ink tank accommodating unit 160 includes a sealing cap 900 for sealing a tip end 800a (see FIG. 7) of the ink introduction member 810.

In a state in which ink is not replenished to the ink tank 700, the tip end 800a of the ink introduction member 810 is sealed by the sealing cap 900. When the ink is replenished to the ink tank 700, the sealing cap 900 is removed from the ink introduction member 810, and a tip end portion of the ink replenishment container 200 is inserted into a position of the ink introduction member 810 to replenish the ink.

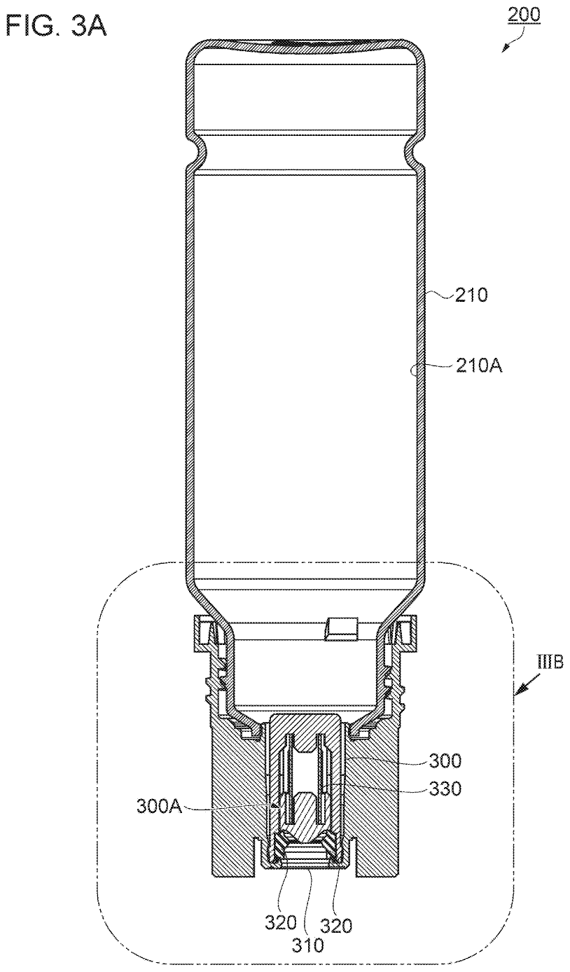

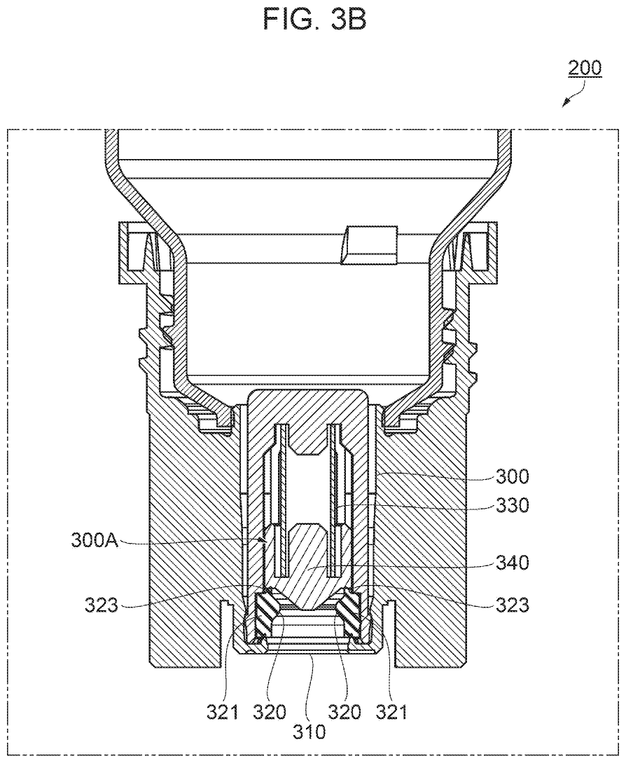

Next, a configuration of the ink replenishment container 200 will be described with reference to FIGS. 3A and 3B.

As shown in FIG. 3A, the ink replenishment container 200 includes a container main body 210 capable of accommodating ink, an ink outlet portion 300, and a valve 300A. The ink outlet portion 300 side of the ink replenishment container 200 is referred to as a “tip end side”, and the container main body 210 side is referred to as a “rear end side”.

The container main body 210 is a hollow cylindrical container having an opening on the tip end side. An ink accommodating portion 210A for accommodating ink is provided in the container main body 210.

The ink outlet portion 300 is used by being coupled to the container main body 210. The ink outlet portion 300 is in fluid communication with the ink accommodating portion 210A. An ink flow path opening 310 is provided at the tip end of the ink outlet portion 300. The valve 300A is disposed in the ink outlet portion 300. When ink is replenished to the ink tank 700, the ink introduction member 810 (see FIG. 5) of the ink tank 700 is inserted into the valve 300A.

The valve 300A is configured to seal the ink flow path opening 310 to prevent the ink from leaking to the outside in a non-replenishment state in which the ink is not replenished to the ink tank 700, and is configured to release the sealing to allow the ink to flow into the ink introduction member 810 in a replenishment state in which the ink is replenished to the ink tank 700.

As shown in FIG. 3B, the valve 300A opens and closes an ink flow path. A valve body 340 is biased by a spring 330 as an elastic member in a first direction from the ink accommodating portion 210A toward the ink flow path opening 310 of the ink outlet portion 300. In a valve-closed state, the valve body 340 is biased in the first direction and is in contact with an annular protrusion 323 of a second seal member 321 serving as a valve seat.

In addition, when the ink introduction member 810 is inserted into the ink outlet portion 300 of the ink replenishment container 200, the valve body 340 is pushed in a second direction opposite to the first direction by the ink introduction member 810 against the bias. When the valve body 340 is pushed in the second direction, the valve body 340 is separated from the annular protrusion 323 of the second seal member 321 to be in a valve-open state (see FIG. 7).

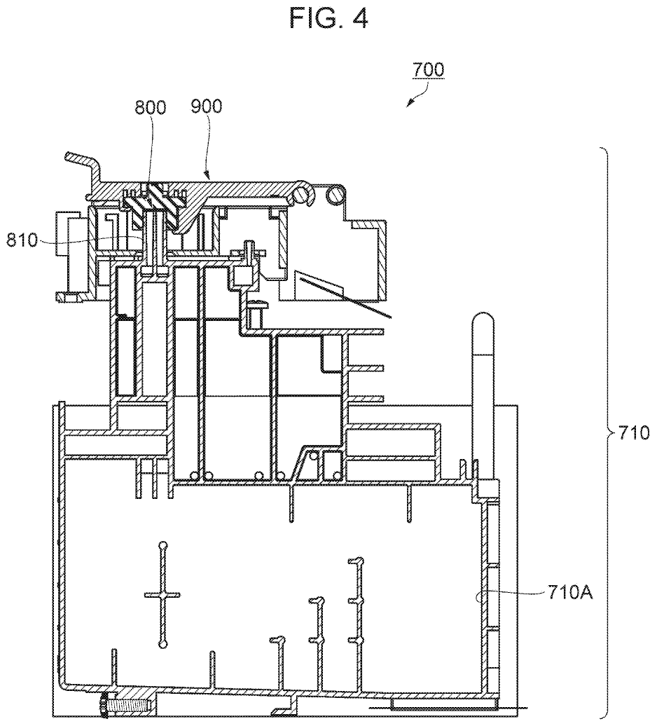

Next, a configuration of the ink tank 700 constituting a part of the printer 100 will be described with reference to FIGS. 4 and 5.

As shown in FIGS. 4 and 5, the ink tank 700 includes a tank main body 710 and the sealing cap 900.

An ink storage portion 710A for storing ink replenished through the ink introduction member 810 is provided in the tank main body 710. As shown in FIG. 5, the ink introduction member 810 has an ink inlet portion 800 at a tip end 800a facing the outside. The ink introduction member 810 is provided in an upper portion of the tank main body 710 so as to protrude upward.

In a state in which the ink replenishment container 200 is coupled to the ink introduction member 810, the ink introduction member 810 opens the valve 300A disposed in the ink outlet portion 300. The ink introduction member 810 is formed in, for example, a tubular shape.

As shown in FIG. 8, the sealing cap 900 is mounted from the tip end 800a side of the ink introduction member 810. The sealing cap 900 includes a first seal portion 910 which seals the ink introduction member 810 from the outside of the printer 100 at a first seal position SP1 in a state where the sealing cap 900 is mounted on the ink introduction member 810.

In the present embodiment, the first seal portion 910 is a portion which comes into contact with the outer peripheral surface of the ink introduction member 810 at a position farthest from the tip end 800a of the ink introduction member 810 among positions which come into contact with the ink introduction member 810, that is, the first seal position SP1. The first seal portion 910 has an annular protruding shape.

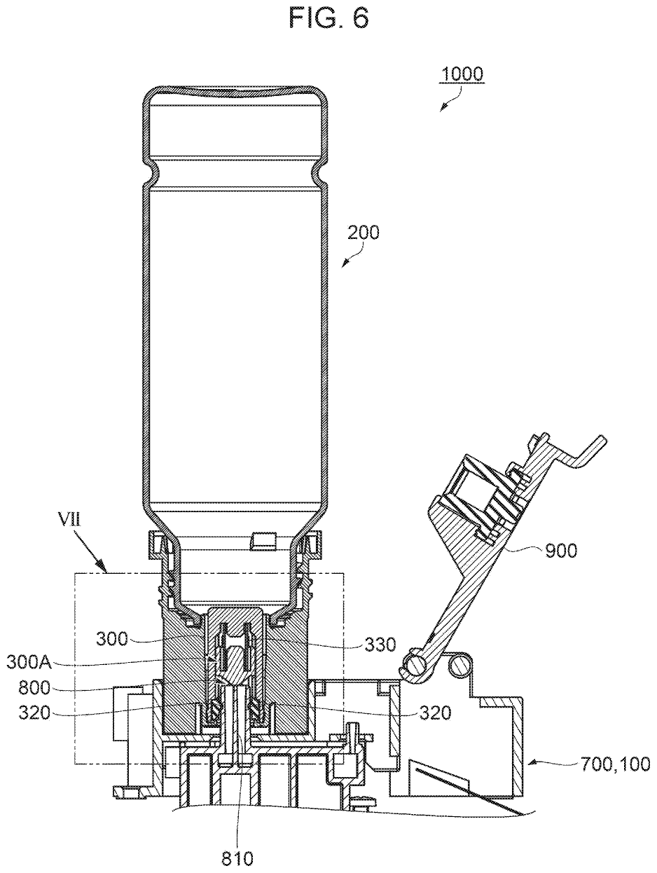

On the other hand, as shown in FIG. 6, the ink outlet portion 300 of the ink replenishment container 200 is provided with a second seal portion 320 for sealing the ink introduction member 810 from the outside in a state in which it is coupled to the ink introduction member 810. As shown in FIG. 3B, the second seal portion 320 is an annular protrusion provided on an inner peripheral surface of the second seal member 321, and comes into contact with the outer peripheral surface of the ink introduction member 810 inserted into the ink outlet portion 300 to seal the ink introduction member 810 from the outside.

That is, the ink introduction member 810 is sealed from the outside by the second seal portion 320 of the ink replenishment container 200 when the ink is replenished, and is sealed from the outside by the first seal portion 910 of the sealing cap 900 when the ink is not replenished.

Next, a configuration of the ink replenishment system 1000 will be described with reference to FIGS. 6 to 10.

As shown in FIG. 6, the ink replenishment system 1000 includes the ink replenishment container 200 and the printer 100 including the ink tank 700.

When the ink is replenished to the printer 100, the ink replenishment container 200 can replenish the ink from the ink replenishment container 200 to the ink tank 700 by coupling the ink outlet portion 300 and the ink introduction member 810 to be in liquid communication with each other.

As shown in FIG. 7, when the ink is replenished, the ink introduction member 810 and the second seal portion 320 of the second seal member 321 of the ink replenishment container 200 come into contact with each other to seal the ink introduction member 810 from the outside. A contact position at which the second seal portion 320 and the ink introduction member 810 come into contact with each other and which is farthest from the tip end 800a of the ink introduction member 810 toward the outside, which is toward the ink flow path opening 310 in the present embodiment, is referred to as a second seal position SP2.

Further, a second sealing region from the tip end 800a of the ink introduction member 810 to the second seal position SP2 is indicated by an arrow H2 in FIG. 7. At the time of ink replenishment, ink adheres to the outer periphery of the ink introduction member 810, and in particular, ink adheres to the outer periphery of the ink introduction member 810 between the tip end 800a and the second seal position SP2.

As shown in FIG. 8, when the ink is not replenished and the sealing cap 900 is mounted on the ink introduction member 810, the ink introduction member 810 and the first seal portion 910 of the first seal member 911 of the sealing cap 900 come into contact with each other, and the ink introduction member 810 is sealed from the outside. A contact position at which the first seal portion 910 and the ink introduction member 810 come into contact with each other and which is farthest from the tip end 800a of the ink introduction member 810 toward the outside is referred to as a first seal position SP1.

Further, a first sealing region from the tip end 800a of the ink introduction member 810 to the first seal position SP1 is indicated by an arrow H1 in FIG. 8. A first sealing region H1 includes a second sealing region H2 and is larger than the second sealing region H2.

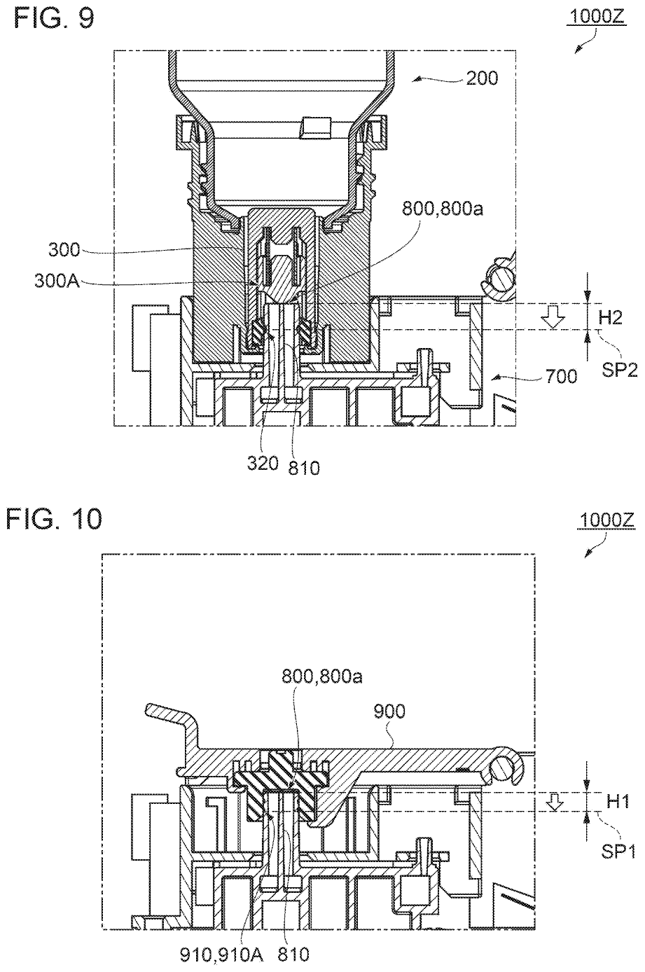

As shown in FIG. 9, an ink replenishment system 1000Z in the related art has an ink replenishment container 200 and an ink inlet portion 800 that are both the same in configuration as the ink replenishment container 200 and the ink inlet portion 800 of the present embodiment.

Further, in the sealing cap 900 of the ink tank 700 in the related art, as shown in FIG. 10, in a state in which the sealing cap 900 is mounted on the ink introduction member 810, a first sealing region H1 from the tip end 800a of the ink introduction member 810 to the first seal portion 910 is smaller than a second sealing region H2 from the tip end 800a to the second seal portion 320 shown in FIG. 9. As described above, in the configuration of the related art, even when the sealing cap 900 is mounted on the ink introduction member 810, a part of the second sealing region H2 is located outside the first sealing region H1. Therefore, in a portion of the ink introduction member 810 that is located in a part of the second sealing region H2 that is located outside the first sealing region H1, ink adhered to the portion is exposed to the outside, and moisture evaporates. As a result, of the components of the ink, for example, slippery components such as glycerin remain, and therefore, when the ink replenishment container 200 is coupled to the ink introduction member 810, the ink replenishment container 200 floats up due to the reaction force of the spring 330 of the valve 300A, and there is a possibility that the ink cannot be appropriately replenished.

However, in contrast to the configuration of the related art, in the present embodiment, since the first sealing region H1 includes the second sealing region H2, a position at which the ink introduction member 810 is sealed from the outside by the sealing cap 900 is deeper than the position at which the ink introduction member 810 is sealed from the outside by the ink replenishment container 200. Therefore, when the ink is not replenished to the printer 100, the sealing cap 900 can seal the ink introduction member 810 from the outside at the first seal position SP1 so as to cover the second seal position SP2.

As a result, it is possible to reduce the occurrence of thickening due to evaporation of moisture from the ink adhering from the tip end 800a having the ink inlet portion 800 of the ink introduction member 810 to the second seal position SP2. Accordingly, even when the ink replenishment container 200 is coupled to the printer 100 to replenish the ink after a lapse of time, at least the ink adhered from the tip end 800a of the ink introduction member 810 to the second seal position SP2 is less likely to thicken. Therefore, it is possible to reduce the likelihood that the ink outlet portion 300 of the ink replenishment container 200 floats up along the ink introduction member 810 of the ink tank 700. As a result, it is possible to reduce a decrease in the replenishment amount of ink or an increase in the replenishment time of ink, and it is possible to normally replenish ink to the printer 100.

In addition, since the first seal portion 910 has the annular protrusion shape, when the ink is not replenished, when the sealing cap 900 is mounted on the ink introduction member 810, it is possible to scrape off the ink adhering to the outer peripheral surface of the ink introduction member 810 by the annular first seal portion 910, and it is possible to reduce the ink adhering to the ink introduction member 810. Therefore, thickening is less likely to occur on the outer peripheral surface of the ink introduction member 810, and it is possible to reduce a decrease in the friction coefficient of a surface from the tip end 800a to the first seal position SP1 of the ink introduction member 810, and it is possible to reduce the likelihood that the ink replenishment container 200 floats up at the time of ink replenishment. As a result, the ink can be appropriately replenished.

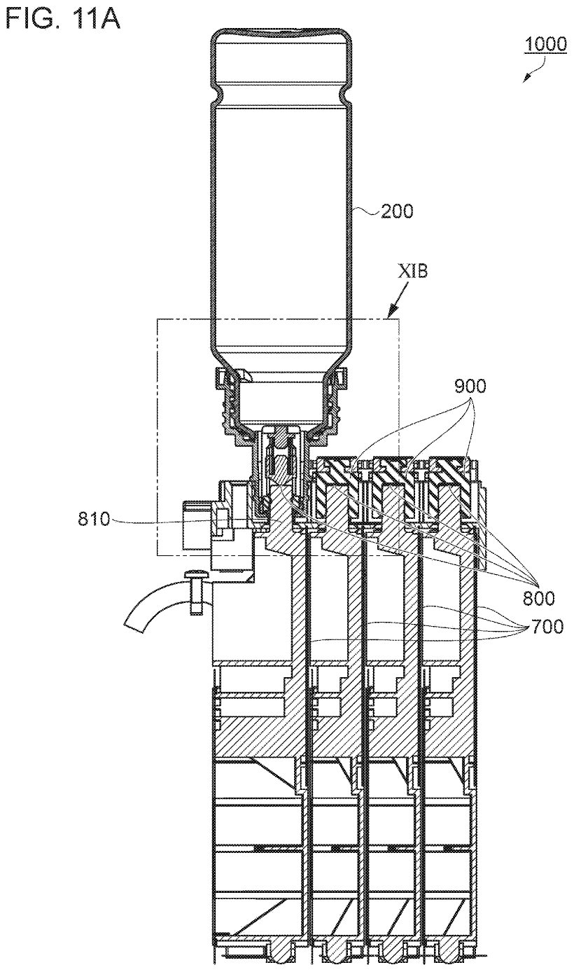

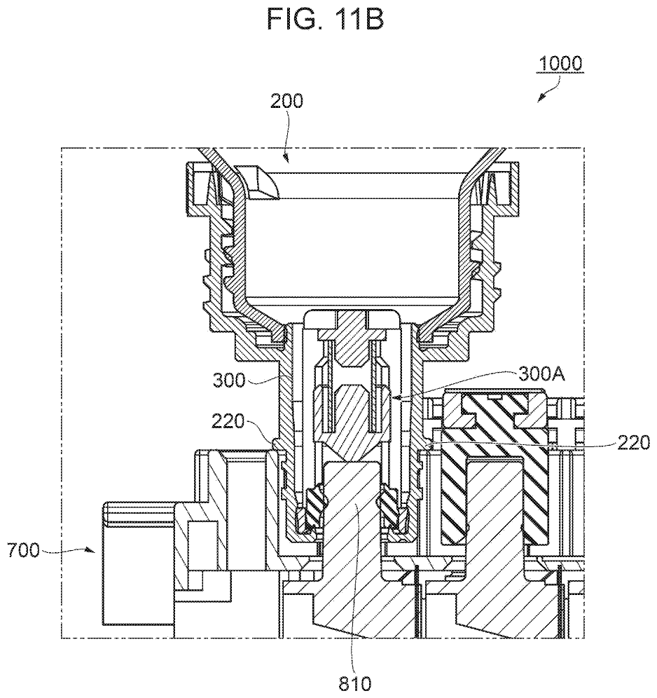

As shown in FIG. 11A and FIG. 11B, it is preferable that the ink replenishment container 200 includes a positioning portion 220 that, in a coupled state with the printer 100, comes into contact with a part of the printer, specifically, a part of a cover member or an adapter member positioned above the ink tank 700, to perform positioning in a coupling direction of the ink outlet portion 300 and the ink introduction member 810.

As described above, since the positioning portion 220 is provided in the ink replenishment container 200, it is possible to prevent the ink replenishment container 200 from being excessively inserted into the printer 100 side. Therefore, it is possible to keep an amount of ink remaining on the outer peripheral surface of the ink introduction member 810 small. In addition, since the second sealing region H2 can be adjusted by the positioning portion 220 so as not to be excessively large, it is easy to avoid an increase in size of the sealing cap 900 which forms the first sealing region H1.

As described above, the ink replenishment system 1000 includes an ink replenishment container 200, and a printer 100 in which ink is replenished to an ink storage portion 710A from the ink replenishment container 200 via an ink introduction member 810. The ink replenishment container 200 includes an ink accommodating portion 210A configured to accommodate ink, an ink outlet portion 300 that is in fluid communication with the ink accommodating portion 210A, and a valve 300A disposed inside the ink outlet portion 300, the valve 300A being closed by being biased in a first direction from the ink accommodating portion 210A toward the ink outlet portion 300 by a spring 330, and the valve 300A being opened by being pushed in a second direction opposite to the first direction against the bias by the ink introduction member 810 that is coupled to the ink outlet portion 300. The printer 100 includes an ink inlet portion 800 at a tip end 800a of the ink introduction member 810. The printer 100 includes a sealing cap 900 mounted from a tip end 800a side of the ink introduction member 810. The sealing cap 900 includes a first seal portion 910 that seals the ink introduction member 810 from an outside at a first seal position SP1 in a state in which the sealing cap 900 is mounted on the ink introduction member 810. The ink outlet portion 300 of the ink replenishment container 200 includes a second seal portion 320 that seals the ink introduction member 810 from the outside at a second seal position SP2 in a state in which the ink outlet portion 300 is coupled to the ink introduction member 810. A first sealing region H1 from the tip end 800a of the ink introduction member 810 to the first seal position SP1 includes a second sealing region H2 from the tip end 800a of the ink introduction member 810 to the second seal position SP2.

According to this configuration, it is possible to reduce the likelihood that moisture evaporates from ink adhering from the tip end 800a of the ink introduction member 810 to the second seal position SP2 and a slippery component remains. Accordingly, even when the ink replenishment container 200 is coupled to the printer 100 and the ink is replenished after a lapse of time, it is possible to reduce the likelihood that the ink outlet portion 300 of the ink replenishment container 200 floats up along the ink introduction member 810. As a result, it is possible to reduce a decrease in the replenishment amount of ink or an increase in the replenishment time of ink, and it is possible to normally replenish ink to the printer 100.

In the ink replenishment system 1000 of the present embodiment, the first seal portion 910 of the sealing cap 900 is preferably an annular protrusion. According to this configuration, because the first seal portion 910 is the annular protrusion, when ink is not replenished and the sealing cap 900 is mounted on the ink introduction member 810, it is possible to scrape ink adhering to the ink introduction member 810 with the annular protrusion, and it is possible to reduce ink that remains adhering to the ink introduction member 810. Therefore, it is possible to reduce a decrease in the friction coefficient of a surface from the tip end 800a to the first seal position SP1 of the ink introduction member 810, and it is possible to reduce the likelihood that the ink replenishment container 200 floats up at the time of ink replenishment. As a result, the ink can be appropriately replenished.

In the ink replenishment system 1000 of the present embodiment, the first seal portion 910 of the sealing cap 900 preferably comes into contact with the outer peripheral surface of the ink introduction member 810 at the first seal position SP1. According to this configuration, although ink easily adheres to the outer peripheral surface of the ink introduction member 810 at the time of ink replenishment, after ink replenishment ends, when the sealing cap 900 is mounted on the ink introduction member 810, the first seal portion 910 of the sealing cap 900 comes into contact with the outer peripheral surface of the ink introduction member 810, so that it is possible to reduce ink adhering to the outer peripheral surface of the ink introduction member 810. As a result, because thickening is less likely to occur on the outer peripheral surface of the ink introduction member 810, it is possible to reduce a decrease in the friction coefficient of the outer peripheral surface, and at the next ink replenishment, it is possible to reduce the likelihood that the ink outlet portion 300 of the ink replenishment container 200 floats up along the ink introduction member 810.

In addition, in the ink replenishment system 1000 of the present embodiment, it is preferable that the ink replenishment container 200 further has a positioning portion 220 that performs positioning in a coupling direction of the ink outlet portion 300 and the ink introduction member 810 in a coupled state with the printer 100 by coming into contact with a part of the printer 100. According to this configuration, because the ink replenishment container 200 includes the positioning portion 220, it is possible to reduce the likelihood that the ink replenishment container 200 is inserted excessively toward the printer 100 side, and therefore it is possible to reduce an amount of ink that remains on the outer peripheral surface of the ink introduction member 810. In addition, since the second sealing region H2 can be adjusted by the positioning portion 220 so as not to be excessively large, it is easy to avoid an increase in size of the sealing cap 900 which forms the first sealing region H1 including the second sealing region H2.

The following describes modifications of the embodiment described above.

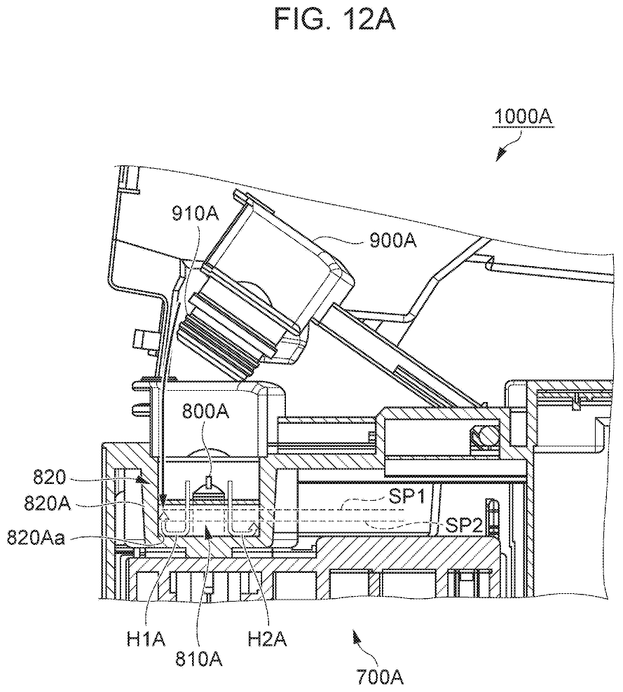

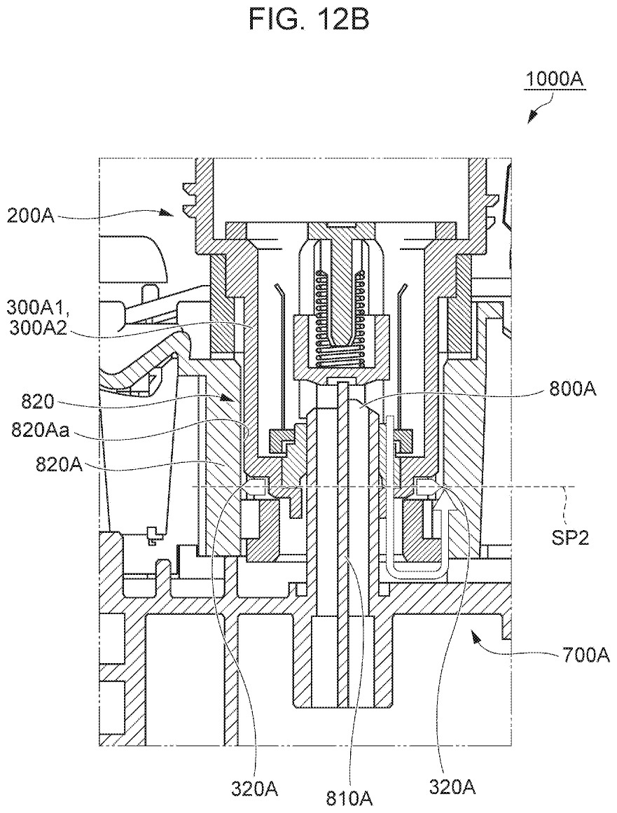

As shown in FIG. 12A, an ink replenishment system 1000A of the modification includes a sealing cap 900A, an ink introduction member 810A, and an ink receiving portion 820 including a wall 820A surrounding the outer periphery of the ink introduction member 810A. When the sealing cap 900A is mounted so as to cover the ink introduction member 810A, the first seal portion 910A provided on the sealing cap 900A comes into contact with an inner peripheral surface 820Aa of the wall 820A of the ink receiving portion 820, thereby sealing the ink introduction member 810A from the outside. A position where the first seal portion 910A and the inner peripheral surface 820Aa come into contact with each other is a first seal position SP1, which is indicated by a dotted line in FIG. 12A. The first sealing region of the ink introduction member 810A is indicated by an arrow H1A in FIG. 12A.

Further, as shown in FIG. 12B, when the ink is replenished, the ink introduction member 810A of the ink tank 700A and the ink outlet portion 300A1 of the ink replenishment container 200A are coupled to each other. The ink replenishment container 200A is provided with a second seal member 321A such as an O-ring disposed on the outer periphery of the ink outlet portion 300A1. The second seal member 321A includes a second seal portion 320A. The second seal portion 320A comes into contact with the inner peripheral surface 820Aa of the wall 820A of the ink receiving portion 820 to seal the ink introduction member 810A of the ink inlet portion 800 at the tip end 800A from the outside. A position at which the second seal portion 320A and the inner peripheral surface 820Aa come into contact with each other is a second seal position SP2, which is indicated by a dotted line in FIG. 12B. The second sealing region of the ink introduction member 810A is indicated by an arrow H2A in FIG. 12B.

When the ink is replenished, the ink replenishment container 200A is coupled to the ink introduction member 810A. During the ink replenishment, the second seal portion 320A of the ink replenishment container 200A is in contact with the inner peripheral surface 820Aa of the wall 820A of the ink receiving portion 820 at the second seal position SP2 to seal the ink introduction member 810A from the outside. Therefore, the tip end 800A having the ink inlet portion 800 of the ink introduction member 810A is sealed from the outside.

After the ink is replenished, the ink replenishment container 200A is removed from the ink introduction member 810A, but the ink adheres to the outer peripheral surface of the ink introduction member 810A. After the ink is replenished, the sealing cap 900A is mounted so as to cover the ink introduction member 810A. As a result, the first seal portion 910A comes into contact with the inner peripheral surface 820Aa of the wall 820A of the ink receiving portion 820 to seal the ink introduction member 810A from the outside at the first seal position SP1.

As shown in FIG. 12A, a first sealing region H1A from the tip end 800A of the ink introduction member 810A to the first seal position SP1 is indicated by an arrow H1A in FIG. 12A. As shown in FIG. 12A, the first sealing region H1A includes a second sealing region H2A. Accordingly, it is possible to reduce the likelihood that moisture in ink adhering to the ink introduction member 810A evaporates and a slippery component remains. As a result, at the time of the next ink replenishment, it is possible to reduce the likelihood that the ink replenishment container 200A floats up along the outer peripheral surface of the ink introduction member 810A, and ink replenishment can be appropriately performed.

It is preferable that the ink replenishment system 1000A of the modification has the ink receiving portion 820 including the wall 820A surrounding the outer periphery of the ink introduction member 810A, and that the first seal portion 910A of the sealing cap 900A comes into contact with the inner peripheral surface 820Aa of the wall 820A of the ink receiving portion 820 in a state in which the sealing cap 900A is mounted, and the second seal portion 320A also comes into contact with the inner peripheral surface 820Aa of the wall 820A of the ink receiving portion 820.

According to this configuration, the first sealing region H1A includes the second sealing region H2A, and thus it is possible to reduce the likelihood that moisture in ink adhering to the ink introduction member 810A evaporates and a slippery component remains. As a result, in the next ink replenishment, it is possible to reduce the likelihood that the ink replenishment container 200A floats up along the outer peripheral surface of the ink introduction member 810A, and it is possible to appropriately perform the ink replenishment.

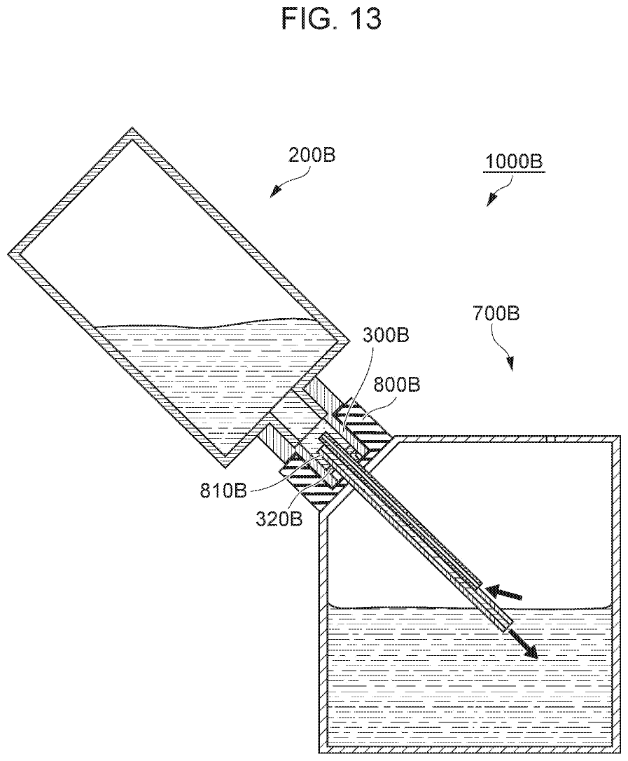

Further, as described above, when the ink is replenished, the ink replenishment container 200 and the ink tank 700 are not limited to being coupled in a vertically standing manner, and may be coupled to each other as shown in FIG. 13.

As shown in FIG. 13, an ink replenishment system 1000B of the modification has an ink tank 700B and an ink replenishment container 200B coupled to the ink tank 700B. The ink introduction member 810B of the ink tank 700B is disposed at a corner portion of the ink tank 700B, rather than on an upper surface of the ink tank 700B, so as to be directed obliquely upward. At the time of ink replenishment, an ink outlet portion 300B of the ink replenishment container 200B is coupled to the ink introduction member 810B of the ink tank 700B. That is, the tip end of the ink replenishment container 200B is coupled obliquely downward, and the ink is replenished obliquely downward from above. Also in this case, although the sealing cap 900 is not shown, it is possible to reduce the likelihood that the ink replenishment container 200B floats up from the ink tank 700B as in the present embodiment.

What is claimed is:

1. An ink replenishment system comprising:
an ink replenishment container; and
a printer in which ink is replenished to an ink storage portion from the ink replenishment container via an ink introduction member, wherein
the ink replenishment container includes
an ink accommodating portion configured to accommodate the ink,
an ink outlet portion that is in fluid communication with the ink accommodating portion, and
a valve disposed inside the ink outlet portion, the valve being closed by being biased in a first direction from the ink accommodating portion toward the ink outlet portion by an elastic member, the valve being opened by being pushed in a second direction opposite to the first direction against the bias by the ink introduction member that is coupled to the ink outlet portion,
the printer includes an ink inlet portion at a tip end of the ink introduction member,
the printer includes a sealing cap mounted from a tip end side of the ink introduction member,
the sealing cap includes a first seal portion that seals the ink introduction member from an outside of the printer at a first seal position in a state in which the sealing cap is mounted on the ink introduction member,
the ink outlet portion of the ink replenishment container includes a second seal portion that seals the ink introduction member from the outside at a second seal position of the ink introduction member in a state in which the ink outlet portion is coupled to the ink introduction member, and
a first sealing region from the tip end of the ink introduction member to the first seal position includes a second sealing region from the tip end of the ink introduction member to the second seal position.

2. The ink replenishment system according to claim 1, wherein
the first seal portion of the sealing cap is an annular protrusion.

3. The ink replenishment system according to claim 1, wherein
the first seal portion of the sealing cap comes into contact with an outer peripheral surface of the ink introduction member at the first seal position.

4. The ink replenishment system according to claim 1, wherein
the ink replenishment container further includes a positioning portion that performs positioning in a coupling direction of the ink outlet portion and the ink introduction member in a coupled state with the ink introduction member by coming into contact with a part of the printer.

5. The ink replenishment system according to claim 1, wherein
the printer further includes an ink receiving portion including a wall surrounding an outer periphery of the ink introduction member, and
the first seal portion and the second seal portion come into contact with an inner peripheral surface of the wall of the ink receiving portion.
